(19) United States
(12) Patent Application Publication
(10) Pub. No.: US 2016/0302001 A1
(43) Pub. Date: Oct. 13, 2016

(54) DISPOSABLE HEADSET PROTECTOR

(71) Applicant: Earbrella, LLC, Roswell, GA (US)

(72) Inventor: Robert Cordes, Roswell, GA (US)

(21) Appl. No.: 15/090,362

(22) Filed: Apr. 4, 2016

Related U.S. Application Data
(60) Provisional application No. 62/144,608, filed on Apr. 8, 2015.

(51) Int. Cl. H04R 1/10; H04R 1/08; H04R 1/28

(52) U.S. Cl. CPC H04R 1/1083; H04R 1/2803; H04R 1/1008; H04R 1/08

(57) ABSTRACT

A headset cover includes a cover body including a stretchable body, wherein the stretchable body is configured to reduce an amount of ambient noise when the stretchable body is placed over at least a portion of the headset, wherein the stretchable body comprises an inner surface and an outer surface, wherein the inner surface defines a body cavity; and a lip, wherein the lip defines a cavity opening, wherein the cavity opening provides access to the body cavity, wherein the lip is configured to secure over at least a portion of the headset. The stretchable material is debris impermeable, fluid impermeable, and disposable.

### CROSS-REFERENCE TO RELATED APPLICATION

This application claims the benefit of U.S. Provisional Application No. 62144608 filed on Apr. 8, 2015, the entirety of which is incorporated herein by reference.

### TECHNICAL FIELD

### Background

The use of headsets has become pervasive in the business world. For example, headsets are commonly used in various settings such as drive-thru restaurants, call centers, police departments, schools, testing centers, hospitals, fire stations, airports, and various other industries. Often times, these work environments have ambient noise or background noise that can impact the effectiveness and efficiency of those individuals working in these types of environments. For example, call centers filled with telephone users need low background noise or the ambient noise reduced in order to effectively and efficiently process calls.

Additionally, in many of these work environments, it is common for a single headset to be shared among multiple users. Sharing headsets typically results in an earpiece or earpieces of a single headset contacting ears of multiple users. At first glance, sharing headsets may appear to be harmless. It is important to note, however, that the standard foam part of a headset cushion or microphone cushion of the earpiece is capable of acting like a sponge. Consequently, headsets can be a breeding a ground for germs, lice, bacteria, and other contaminants. To this end, the headphone or microphone cushion may absorb perspiration, germs, bacteria, viruses, and other contaminants. Therefore, sharing headsets may allow cross-contamination between multiple users of a single headset. For example, ear infections can potentially be caused by the extensive use of headsets. Ideally, each individual should have his or her own headset; although this still may pose some healthcare issues. In other work environments, sharing from a pool of headsets may be unavoidable.

### SUMMARY

Although cleaning headsets on a regular basis with anti-bacterial solvents can help to minimize the risk of infections and other diseases or transference of bacteria from one individual to another, disposable sanitary headphone and microphone covers can provide a sterile protection for users of headphones and headsets resulting in safer work environments for employees. Also, disposable sanitary headphone or microphone covers can preserve the quality of the headset and headphone equipment, allowing them to remain fully operable for longer periods of time.

Accordingly, it is a principal aspect of the present disclosure to provide an apparatus and method that overcomes the drawbacks of prior-art systems.

Yet, another aspect is to provide such apparatus and method that can be used with any style of headset or headphone without affecting the quality of the equipment.

Another aspect is to provide such apparatus and method that provides a safe working environment for industries that utilize headsets or headphones as a component of conducting business.

It is also an aspect of the present disclosure to provide such apparatus and method that can be cost-effectively manufactured and practiced, respectively.

Yet, another aspect of the present disclosure is to provide such apparatus and method for maintaining sterile components of headsets and headphones that may come in contact with a user's ear.

Disclosed is a headset cover comprising: a stretchable body, the stretchable body having an inner surface and an outer surface, the inner surface defining a body cavity; and a lip, the lip defining a cavity opening providing access to the body cavity. Various implementations described in the present disclosure may include additional systems, methods, features, and advantages, which may not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The features and components of the following figures are illustrated to emphasize the general principles of the present disclosure. Corresponding features and components throughout the figures may be designated by matching reference characters for the sake of consistency and clarity.

FIG. 1 is an example perspective view of a headset cover including a body and a lip in accordance with an embodiment of the present disclosure attached to a first embodiment of a headset.

FIG. 2 is an example front view of the headset cover of FIG. 1 on the headset of FIG. 1.

FIG. 3 is an example back view of the headset cover of FIG. 1 on the headset of FIG. 1.

FIG. 4 is an example right-side view of the headset cover of FIG. 1 on the headset of FIG. 1.

FIG. 5 is an example left-side view of the headset cover of FIG. 1 on the headset of FIG. 1.

FIG. 6 is an example top view of the headset cover of FIG. 1 on the headset of FIG. 1.

FIG. 7 is an example bottom view of the headset cover of FIG. 1 on the headset of FIG. 1.

FIG. 8 is an example detailed view of the headset cover of FIG. 1 on the headset of FIG. 1.

FIG. 9 is an example perspective view of the headset cover of FIG. 1 attached to a second embodiment of a headset.

FIG. 10 is an example detailed view of the headset cover of FIG. 1 on the headset of FIG. 9.

FIG. 11 is an example perspective view of the headset cover of FIG. 1 attached to a third embodiment of a headset.

FIG. 12 is an example detailed view of the headset cover of FIG. 1 on the headset of FIG. 11.

FIG. 13 is an example front view of the headset cover of FIG. 1.

FIG. 14 is an example bottom view of the headset cover of FIG. 1.

### DETAILED DESCRIPTION

The present disclosure relates to an ambient noise reduction apparatus and method for implementation of the same. One embodiment of the present disclosure includes a headset protector and associated methods, systems, devices, and various apparatus. The headset protector includes a lip and a body. It would be understood by one of skill in the art that the disclosed headset protector is described in but a few exemplary embodiments among many. No particular terminology or description should be considered limiting on the disclosure or the scope of any claims issuing therefrom.

The headset protector may be configured to be connected to at least a portion of a headset or headphone device, such as, for example, an earpiece, an earphone cushion, a microphone, or a microphone cushion. The headset protector may include a stretchable body or a flexible body which may be constructed from various impermeable and flexible materials such as those from the group including, but not limited to, polyisoprene, latex, nitrile, various other plastics or rubbers, or various other similar materials. The stretchable body of the headset protector may reduce an amount of ambient noise when the headset protector is secured over at least a portion of the headset such as an earpiece, an earphone cushion, a microphone, or a microphone cushion.

The headset protector may be used to prevent various components of a headset such as, for example, an earpiece, an earphone cushion, a speaker cushion, a microphone, or a microphone cushion from absorbing germs, lice, bacteria, and other contaminants in order to prevent the transference of such contaminants between multiple users of headsets or headphone devices. To this end, the stretchable body of the headset protector may provide an impermeable barrier. For example, the stretchable body may include an inner surface and an outer surface such that debris and/or fluid may not flow from a user's ear to the portion of the headset covered by the headset protector. Similarly, debris and/or fluid may not flow from the portion of the headset covered by the headset protector to a user's ear.

Additionally, the outer surface of the stretchable body of the headset protector may be configured to adhere to at least a portion of a user's ear allowing the headset protector to remain in contact with the user's ear and preventing the headset from sliding, slipping, and/or otherwise moving along the user's face. To this end, the stretchable body may be constructed from a material that results in additional friction between the headset cushion and the user's ear which may result in less slippage that other prior art systems. In the following discussion, a general description of the apparatus and its components is provided followed by a discussion of the operation of the same.

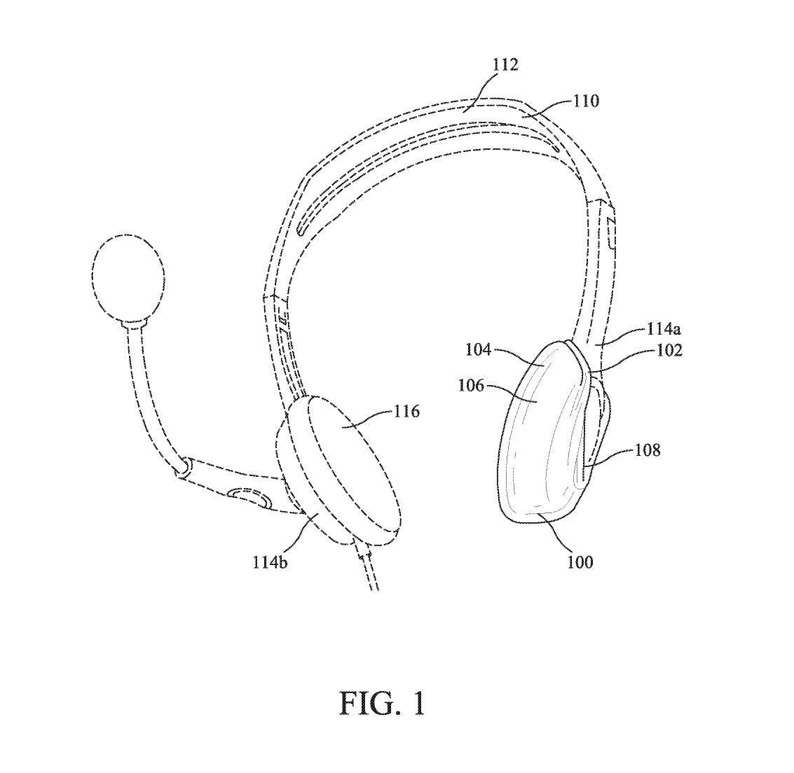

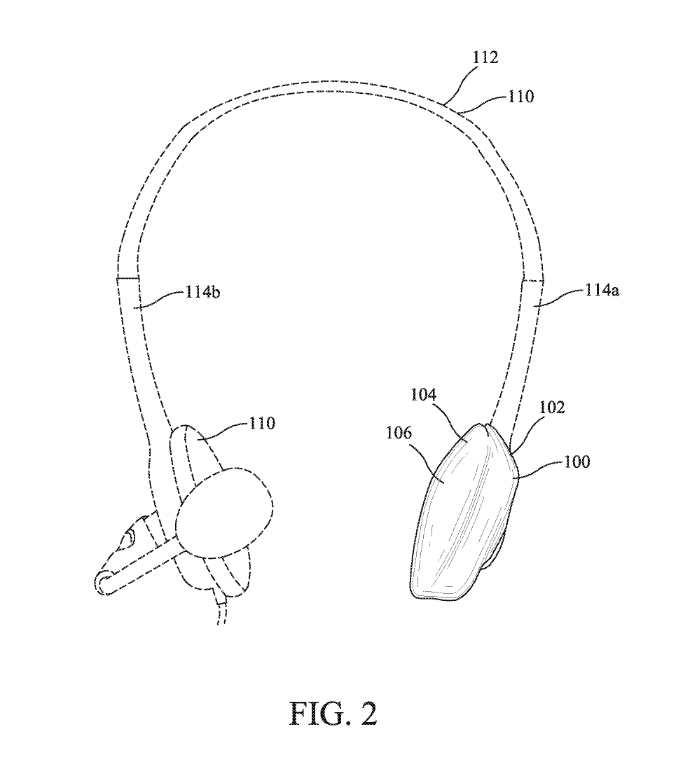

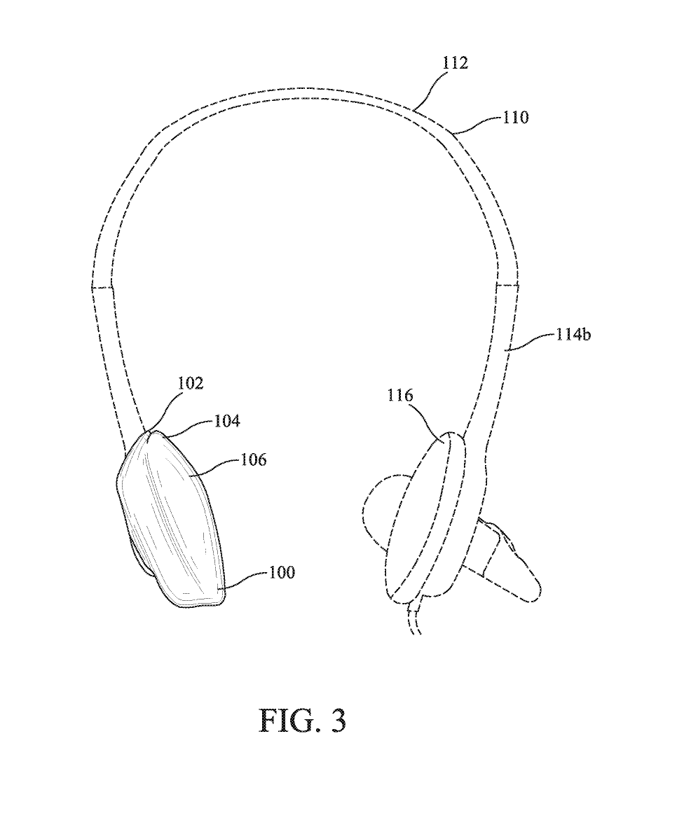

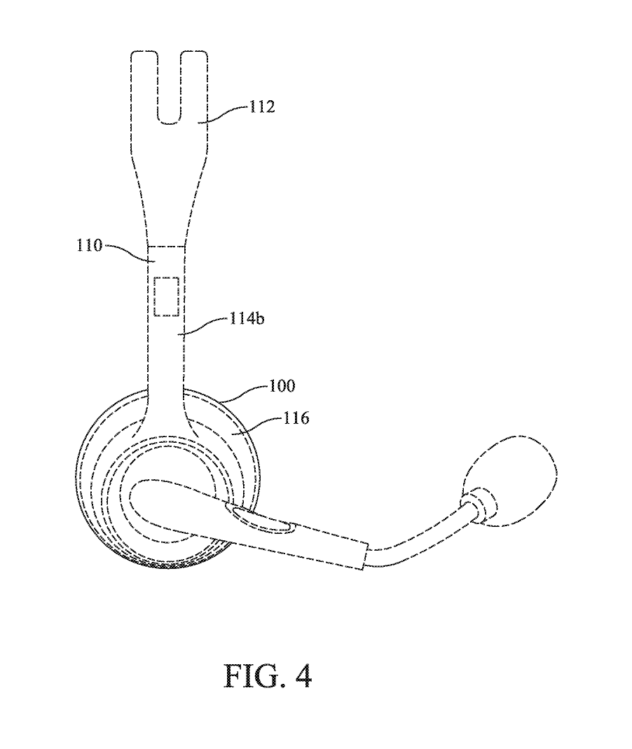

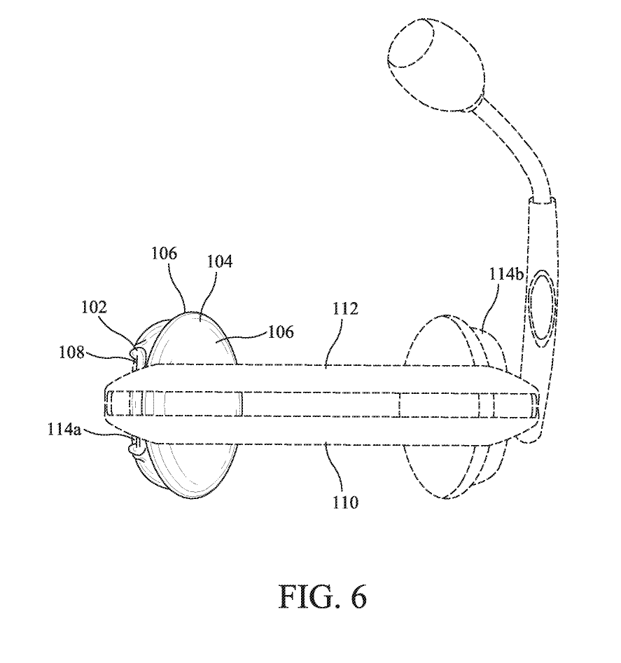

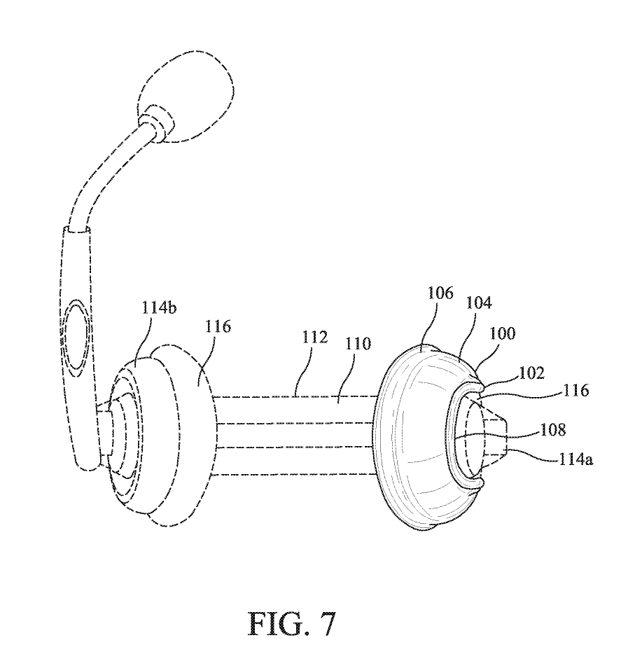

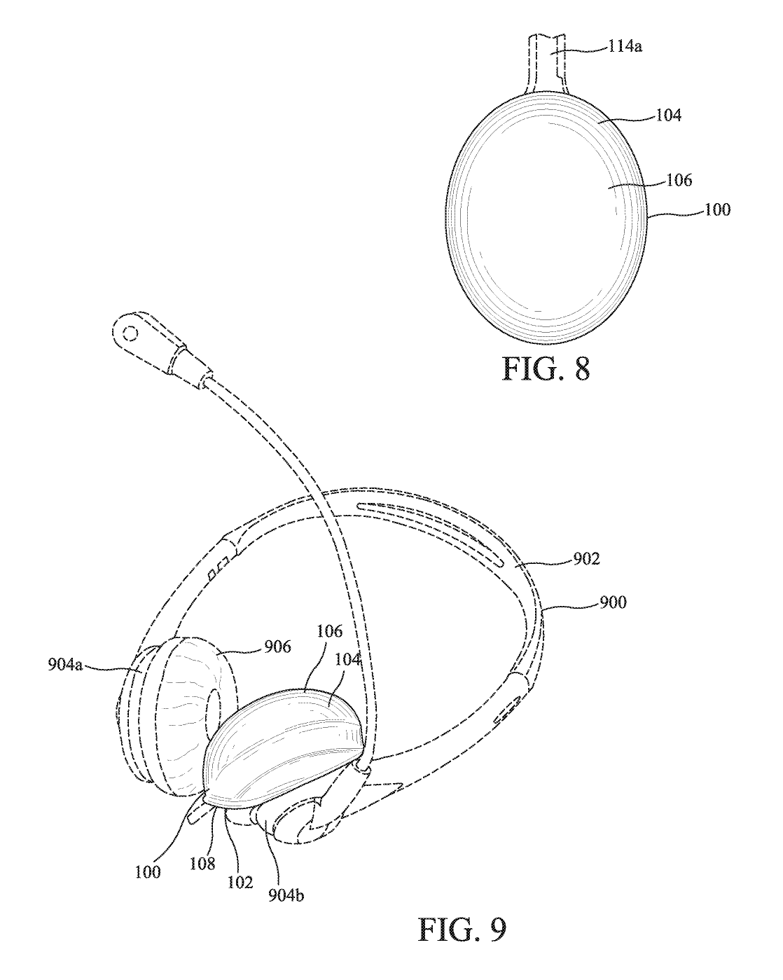

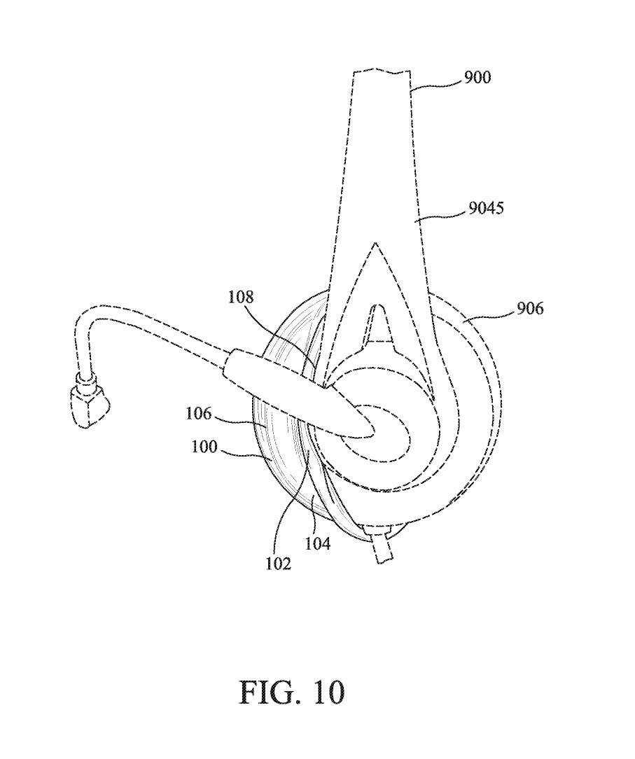

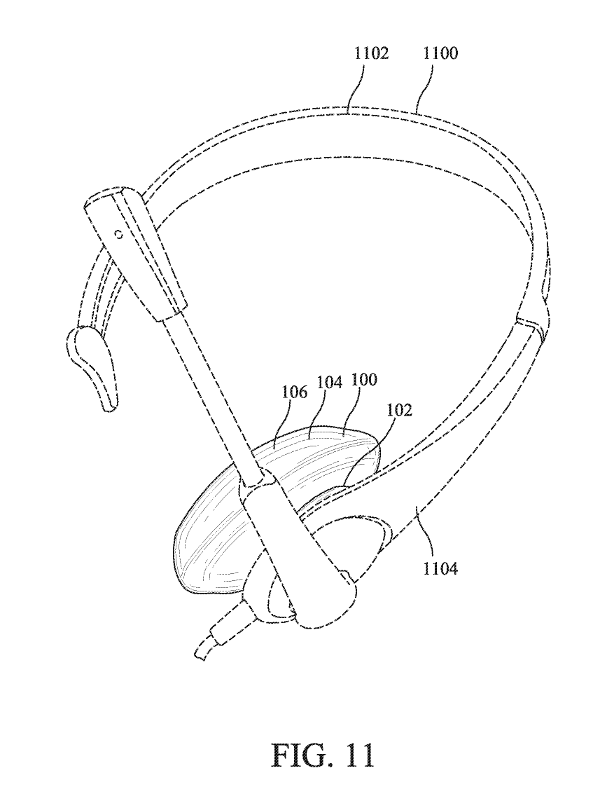

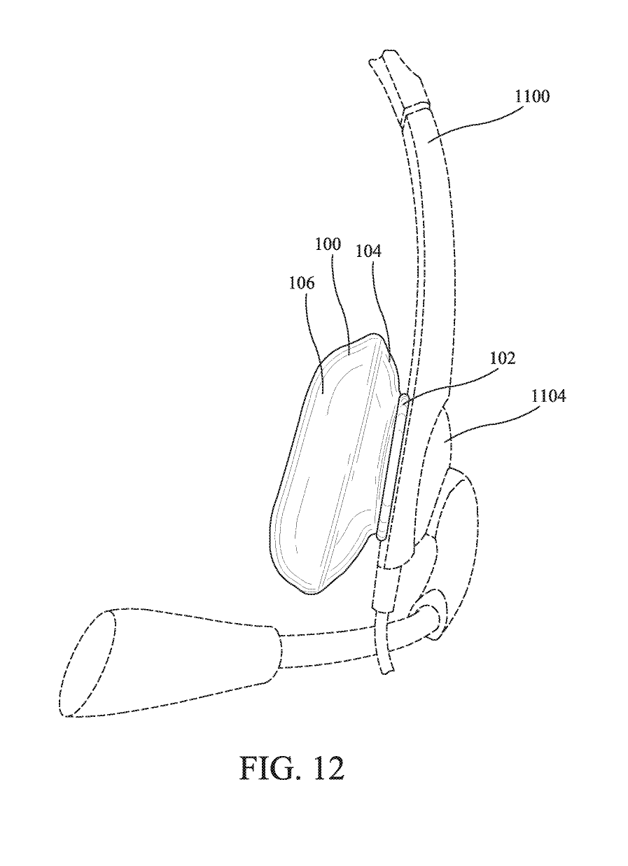

One embodiment of a headset protector 100 is disclosed and described in FIG. 1. As shown in FIG. 1, the headset protector 100 includes a lip 102 and a body 104. In various embodiments, the headset protector 100 is attachable to any style or type of headset worn over a user's ear. FIGS. 1-8 show the headset protector 100 attached to a first headset 110. FIGS. 9 and 10 show the headset protector 100 attached to a second headset 900. FIGS. 11 and 12 show the headset protector 100 attached to a third headset 1100. The disclosure of the headsets 110, 900, 1100 should not be considered limiting on the current disclosure as in various embodiments, the headset protector 100 is attachable to any style or type of headset.

The headset protector 100 includes the lip 102 and the body 104. In various embodiments, the lip 102 is a closure mechanism which secures the headset protector 100 to at least portion of a headset, such as at least a portion of an earpiece, when the headset protector 100 is attached. In various embodiments, the headset protector 100 is secured to at least one earpiece 114a of the headset. The body 104 has an outer surface 106 and an inner surface 1400 (shown in FIG. 14). In various embodiments, the inner surface 1400 of the body 104 defines a body cavity 1402 (shown in FIG. 14) and the lip 102 defines a cavity opening 108. In various embodiments, at least a portion of a headset, such as an earpiece, is inserted through the cavity opening 108 and into the body cavity 1402. In various embodiments, the outer surface of the body 104 of the headset protector 100 may adhere to at least a portion of an ear of a user of the headset to prevent the earpiece from slipping, sliding, or otherwise moving over the face of a user of a headset. Instead, the friction between the outer surface of the headset protector 100 and the headset cushion allows the earpiece of the headset to remain in contact with a user's ear.

In various embodiments, the body 104 is a single layer having a body thickness. In various embodiments, the body thickness may be from 0.005 inches to 0.012 inches. In various embodiments, the body thickness may be about 0.008 inches. In other embodiments, the body thickness may be outside the range of 0.005 inches to 0.012 inches.

In various embodiments, the headset protector 100 is water and debris resistant. In various embodiments, the headset protector 100 is an impermeable barrier attached to a portion of the headset. In various embodiments, the headset protector 100 is impermeable to fluid. In various embodiments, the headset protector 100 is impermeable to debris. In various embodiments, the headset protector 100 is a germ barrier. In various embodiments, the headset protector 100 is an impermeable barrier positioned around an ear-hole of a headset. In various embodiments where the headset protector 100 is an impermeable barrier, the headset protector 100 may protect against germs, lice, and other contaminants that may be spread between multiple users of the headset 100. In various embodiments, the headset protector 100 is flexible or stretchable such that the headset protector 100 can accommodate any type or style of headset. In various embodiments, the headset protector 100 is constructed from various impermeable and flexible materials such as those from the group including, but not limited to, polyisoprene, latex, nitrile, various other plastics or rubbers, or various other similar materials. In various embodiments, the headset protector 100 is a sound dampener that reduces the transmission of unwanted sound waves to the user. In various embodiments, the headset protector 100 acts as a sound dampener when placed over an earpiece of a headset. In these embodiments, the headset protector 100 provides ambient noise reduction such that the amount of ambient or outside noise heard by the user through the headset is significantly diminished or dampened. To this end, the ambient noise reduction may result from the sound first passing through the nitrile membrane of the body 104 and then through to the headset speaker cushion. For example, the apparatus described herein averages about eight decibels (8 db) of ambient noise reduction measured in octaves above seven hundred hertz (700 Hz). For signals coming from the headset to the ear, the present disclosure has no significant reduction until at least the 8 kHz octave band is reached, and the present disclosure allows speech from the earpiece to pass virtually unaffected to the ear of a user of the headset.

In various embodiments, the headset protector 100 is disposable such that a user may easily remove and replace headset protectors 100 on a headset and thereby reducing the potential for a user to contract a disease or illness from germs present on the earpieces and cushions of the headset. In various embodiments, the headset protector 100 may include designs or graphics integrated with the material of the headset protector 100 or printed on the material of the headset protector 100. In various embodiments, the headset protector 100 is formed through a molding mechanism such as dip molding; however, in various other embodiments, other molding techniques suitable for forming the headset protector 100 with the body 104 and lip 102 may be utilized.

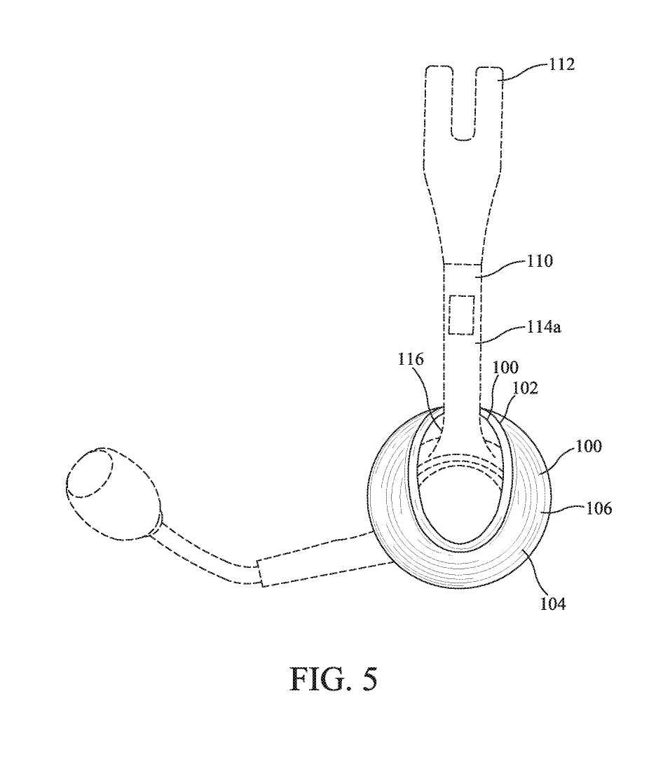

As shown in FIGS. 1-8, in various embodiments, the first headset 110 includes a headband 112 and at least one earpiece 114. In the present embodiment, the first headset 110 includes a left earpiece 114a and a right earpiece 114b. In various embodiments, each earpiece 114a,b includes a cushion 116 (cushion 116 for the left earpiece 114a shown in FIG. 5); however, the disclosure of the earpiece 114a,b should not be considered limiting on the current disclosure. As shown in FIG. 1, in various embodiments, the headset protector 100 is attached over an earpiece 114, such as left earpiece 114a. In various embodiments, at least a portion of the left earpiece 114a is inserted through the cavity opening 108 and into the body cavity 1402 (not shown). As shown in FIG. 1, the headset protector 100 covers at least a portion of the left earpiece 114a. The lip 102 of the headset protector 100 secures the headset protector 100 to the left earpiece 114a. Reference to the left earpiece 114a should not be considered limiting on the current disclosure as the discussion is equally applicable to the right earpiece 114b. In various embodiments an additional headset protector 100 is placed over the right earpiece 114b so that both left earpiece 114a and right earpiece 114b are covered.

As shown in FIGS. 9 and 10, in various embodiments, the second headset 900 includes a headband 902 and at least one earpiece 904a. In the present embodiment, the second headset 900 includes a left earpiece 904a and a right earpiece 904b. In various embodiments, each earpiece 904a,b includes a cushion 906 (cushion 906 for the left earpiece 904a shown in FIG. 10); however, the disclosure of the earpieces 904a,b should not be considered limiting on the current disclosure. As shown in FIGS. 9 and 10, in various embodiments, the headset protector 100 is attached over an earpiece 904, such as left earpiece 904a. In various embodiments, at least a portion of the left earpiece 904a is inserted through the cavity opening 108 and into the body cavity 1402 (not shown). As shown in FIGS. 9 and 10, the headset protector 100 covers at least a portion of the left earpiece 904a. The lip 102 of the headset protector 100 secures the headset protector 100 to the left earpiece 904a. Reference to the left earpiece 904a should not be considered limiting on the current disclosure as the discussion is equally applicable to the right earpiece 904b.

As shown in FIGS. 11 and 12, in various embodiments, the third headset 1100 includes a headband 1102 and an earpiece 1104. In the various embodiments, the earpiece 1104 includes a cushion (not shown); however, the disclosure of the earpiece 1104 should not be considered limiting on the current disclosure. As shown in FIGS. 11 and 12, in various embodiments, the headset protector 100 is attached over the earpiece 1104. In various embodiments, at least a portion of the earpiece 1104 is inserted through the cavity opening 108 (not shown) and into the body cavity 1402 (not shown). As shown in FIGS. 11 and 12, the headset protector 100 covers at least a portion of the earpiece 1104. The lip 102 of the headset protector 100 secures the headset protector 100 to the earpiece 1104.

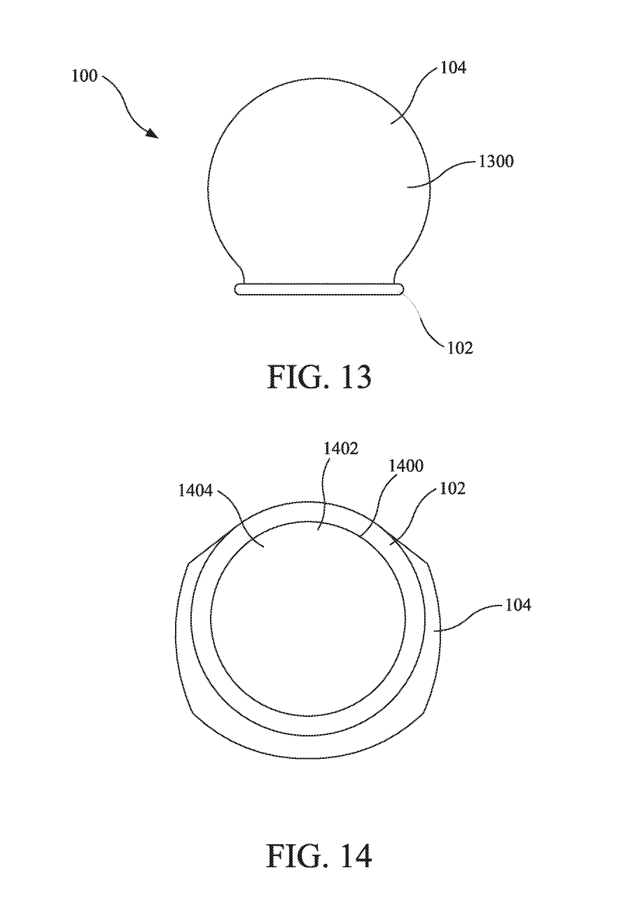

FIGS. 13 and 14 show the headset protector 100 in greater detail. FIGS. 13 and 14 are photographs of the headset protector 100 with lines added for clarity. As shown in FIGS. 13 and 14, in various embodiments, the body 104 and lip 102 may have any desired shape suitable for covering at least a portion of a headset. In the present embodiment, the body 104 has a generally circular front profile, as shown in FIG. 13; however, the shape or profile of the body 104 should not be considered limiting on the current disclosure as in various other embodiments, the body 104 may have any desired shape such as angled, elliptical, cylindrical, square, or any other suitable shape. As shown in FIG. 14 and as previously described, the body 104 has the inner surface 1400 defining the body cavity 1402. In various embodiments, at least a portion of a headset, such as an earpiece, is inserted through the cavity opening 108 and into the body cavity 1402.

The headset protector 100 may be easily placed over a functioning component of a headset such as, for example, an earpiece or microphone prior to use by a particular user of the headset. Once the user of the headset is done using the headset, the user may remove and dispose of the headset protector 100. When a different user desires to use the headset, a different headset cover 100 may simply be placed over the corresponding functioning components of the headset.

To practice the method of the present disclosure, the user selects a material such as, polyisoprene, latex, nitrile, various other plastics or rubbers, or various other similar materials having substantial sound dampening properties. The user may then form the material into a headset protector 100 and place the headset protector 100 over at least a portion of the headset. In one embodiment, the headset protector 100 may correspond to an earpiece cover. In another embodiment, the headset protector 100 may correspond to a microphone cover. In yet other embodiment, the headset protector 100 may correspond to an earpiece cushion cover.

The present disclosure achieves the above aspects by providing both an apparatus and a method that overcomes the drawbacks of prior-art systems. The apparatus and the method of the present disclosure provide a safe working environment for industries that utilize headsets or headphones to conduct business. The method of the present disclosure also allows for maintaining sterile components of headsets and headphones that come in contact with a user's ear. The headset protector 100 may be lightweight and the method of using the headset protector 100 is not time-consuming. The material choice of 0.008-inch-thick nitrile makes the apparatus of the present disclosure cost effectively manufactured and practiced.

Accordingly, while a preferred embodiment of the present disclosure is described herein, it is appreciated that modifications are possible that are within the scope of the present disclosure. One should note that conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more particular embodiments or that one or more particular embodiments necessarily include logic for deciding, with or without user input or prompting, whether these features, elements and/or steps are included or are to be performed in any particular embodiment.

It should be emphasized that the above-described embodiments are merely possible examples of implementations, merely set forth for a clear understanding of the principles of the present disclosure. Many variations and modifications may be made to the above described embodiment(s) without departing substantially from the spirit and principles of the present disclosure. Further, the scope of the present disclosure is intended to cover any and all combinations and sub-combinations of all elements, features, and aspects discussed above. All such modifications and variations are intended to be included herein within the scope of the present disclosure, and all possible claims to individual aspects or combinations of elements or steps are intended to be supported by the present disclosure.

That which is claimed is:

1. An apparatus connectable to at least a portion of a headset comprising:
a stretchable body, wherein the stretchable body is configured to reduce an amount of ambient noise when the stretchable body is placed over at least a portion of the headset, wherein the stretchable body comprises an inner surface and an outer surface, wherein the inner surface defines a body cavity; and
a lip, wherein the lip defines a cavity opening, wherein the cavity opening provides access to the body cavity, wherein the lip is configured to secure over at least a portion of the headset.

2. The apparatus of claim 1, wherein the at least a portion of the headset corresponds to at least a portion of an earpiece, wherein the earpiece is associated with the headset.

3. The apparatus of claim 1, wherein the at least a portion of the headset corresponds to at least a portion of a microphone, wherein the microphone is associated with the headset.

4. The apparatus of claim 1, wherein the at least a portion of the headset corresponds to at least a portion of a speaker cushion, wherein the speaker cushion is associated with the headset.

5. The apparatus of claim 1, wherein the stretchable body is made of nitrile.

6. The apparatus of claim 1, wherein the stretchable body has a thickness of 0.008 inches.

7. The apparatus of claim 1, wherein the stretchable body has a thickness between 0.005 inches and 0.012 inches.

8. The apparatus of claim 1, wherein the amount of ambient noise reduction corresponds to 8 db for frequencies greater than 700 Hz.

9. The apparatus of claim 1, wherein the outer surface of the stretchable body is configured to adhere to at least a portion of an ear of a user of the headset.

10. The apparatus of claim 1, wherein the stretchable body comprises an impermeable barrier.

11. A method of reducing ambient noise utilizing a headset, comprising:
selecting a material having substantial sound dampening properties.
forming the material into an earphone cover; and
arranging the earphone cover to be placed over at least a portion of a corresponding earphone cushion.

12. The method of claim 11 wherein the material corresponds to nitrile.

13. The method of claim 11, wherein the earphone cover comprises:
a body, wherein the body comprises an impermeable barrier; and
a lip, wherein the lip is configured to secure the earphone cover over at least a portion of the earphone cushion.

14. The method of claim 13, wherein the lip comprises a closure mechanism.

15. The method of claim 13, wherein the impermeable barrier corresponds to a fluid impermeable barrier.

16. The method of claim 13, wherein the impermeable barrier corresponds to a debris impermeable barrier.

17. The method of claim 11, wherein the earphone cover is configured to be attached to a plurality of types of headsets.

18. The method of claim 11, wherein the earphone cover is formed using a molding mechanism.

19. The method of claim 18, wherein the molding mechanism corresponds to a dip molding.

20. The method of claim 11, wherein an average of amount of ambient noise reduced corresponds to 8 db for frequencies greater than 700 Hz.
